(19) United States
(12) Patent Application Publication
(10) Pub. No.: US 2011/0098923 A1
(43) Pub. Date: Apr. 28, 2011

(54) METHOD OF AND APPARATUS FOR CREATING MAP OF ARTIFICIAL MARKS, AND METHOD AND APPARATUS FOR MEASURING POSITION OF MOVING OBJECT USING THE MAP

(75) Inventor: Yu-Cheol LEE, Daejeon (KR)

(73) Assignees: Electronics and Telecommunications Research Institute, Daejeon (KR); SK Telecom Co., Ltd., Seoul (KR)

(21) Appl. No.: 12/912,199

(22) Filed: Oct. 26, 2010

(30) Foreign Application Priority Data
Oct. 26, 2009 (KR) 10-2009-0101674
Dec. 21, 2009 (KR) 10-2009-0128336

(51) Int. Cl. G01C 21/00; G06F 17/00

(52) U.S. Cl. 701/208; 701/300; 701/207

(57) ABSTRACT

A method of creating a map of artificial marks includes acquiring a position in which a moving object is moved, detecting each of the artificial marks to obtain an image thereof, calculating a relative position of the detected artificial mark, calculating a position of the detected artificial mark in a global coordinate system using the relative position, and storing the calculated position and an ID of the detected artificial mark in a map database to create the map of the artificial marks. Further, a method of measuring a position of a moving object includes detecting an artificial mark within a search range calculating a relative position of the detected artificial mark, and calculating a position of the moving object using the calculated relative position and a position in a global coordinate system corresponding to the relative position of the detected artificial mark from the map database.

### CROSS-REFERENCE TO RELATED APPLICATIONS

The present invention claims priority of Korean Patent Application Nos. 10-2009-0101674, filed on Oct. 26, 2009 and 10-2009-0128336, filed on Dec. 21, 2009, which are incorporated herein by reference.

### FIELD OF THE INVENTION

The present invention relates to a method and an apparatus of creating a map of artificial marks, and more particularly to, a method and apparatus for creating a map of artificial marks that are installed in an indoor space. Further, the present invention relates to a method and an apparatus for measuring the position of a moving object using the map of the artificial marks.

### BACKGROUND OF THE INVENTION

As well known in the art, an autonomous mobile robot is employed in various fields, for example, they assist handicapped persons, transport products in a factory, perform space exploration, and perform working in a dangerous place such as a nuclear dumpsite, in lieu of human beings. In addition, the mobile robot is used for various purposes such as cleaning, guidance, crime prevention, etc.

Such development in mobile robots does not only make the lives of human beings more comfortable but also provides a new high value-added market to enterprises. To this end, the mobile robot equips with various sensors providing functions corresponding to eyes, nose, and mouth of human, but fails to provide various services due to a limited performance of the sensors. Thus, in order to overcome such a limitation, many research and development to improve the intelligence and recognition capabilities of the mobile robot have conducted all over the world.

Especially, autonomous navigation technology of a mobile robot is one of the fields in which much research is being conducted and enables the mobile robot itself to navigate safely toward a target. To this end, the technologies of mapping, localization, and path planning of the mobile robot are required and the development of the technologies are conducting in order to improve the navigation performance of the mobile robot. In the navigation technology of a mobile robot, the mapping and the localization of the mobile robot are interconnected in complex ways. That is, accurate location estimation is required for creating an accurate map, and the creation of an accurate map is essential for enabling a robot to accurately estimate its position. For these reasons, the mapping technology and the localization technology are being studied in association with each other. If even only one of the mapping and localization technologies can be perfectly implemented, a performance satisfying both of the technologies can be more easily derived.

Based on this principle, a technique for measuring the position of a mobile robot by installing artificial marks for the localization of the mobile robot is frequently used. The technology of measuring a position of the mobile robot using artificial marks that are installed on the ceiling in an indoor space is referred to as an artificial mark-based positioning technology. The artificial mark-based positioning technology classified into radio measuring type and an image processing type. The image processing type may provide more correct position information to the moving object than the radio measuring type, but to this end, the artificial marks should be installed on the ceiling and position information of the artificial marks should be provided to the mobile robot moving object in advance.

Further, the artificial mark-based positioning technology has the fundamental problem of high costs in terms of time and labor because a human user has to manually create a map on the position of the artificial marks.

### SUMMARY OF THE INVENTION

In view of the forgoing, the present invention provides a method and an apparatus for creating a map of artificial marks that are installed in an indoor space.

Further, the present invention provides a method and an apparatus for measuring the position of a moving object using the map of the artificial marks.

In accordance with a first aspect of the present invention, there is provided a method of creating a map of artificial marks installed in an indoor space, the method including:

acquiring a position in which a moving object is moved in the indoor space;

detecting each of the artificial marks to obtain an image of the detected artificial mark;

calculating a relative position of the detected artificial mark using the position of the moving object and the image of the detected artificial mark;

calculating a position of the detected artificial mark in a global coordinate system using the calculated relative position; and

storing the calculated position in the global coordinate system and an ID of the detected artificial mark in a map database to create the map of the artificial marks.

In accordance with a second aspect of the present invention, there is provided an apparatus for creating a map of artificial marks installed in an indoor space, the apparatus including:

a moving object travelling in the indoor space using a wheel, the moving object including an artificial mark detector mounted to the moving object for detecting each of the artificial marks to obtain an image of the detected artificial mark;

a relative position calculation unit for calculating a relative position of the detected artificial mark using a position in which the moving object is moved and the image of the detected artificial mark; and

a map creation device for calculating a position of the detected artificial mark in a global coordinate system using the calculated relative position; and

a map database storing the calculated position of the detected artificial mark in a global coordinate system.

In accordance with third aspect of the present invention, there is provided a method of measuring a position of a moving object, the method including:

acquiring a position in which the moving object is moved in an indoor space;

detecting each of artificial marks installed in an indoor space to obtain an image of the detected artificial marks;

calculating a relative position of the detected artificial mark using the image of the detected artificial mark and the position of the moving object;

obtaining a position in a global coordinate system corresponding to the relative position of the detected artificial mark; and

measuring a position of the moving object using the relative position and the position in the global coordinate system of the detected artificial mark.

In accordance with fourth aspect of the present invention, there is provided an apparatus for measuring a position of a moving object, the apparatus including:

a map database storing positions in a global coordinate system of artificial marks installed in an indoor space, wherein each of the artificial marks has an ID assigned thereto to distinguish one another;

an artificial mark detector mounted to the moving object for detecting each of the artificial marks within a search range to acquire an image of the detected artificial mark;

a relative position calculation unit for calculating a relative position of the detected artificial mark by analyzing the acquired image; and

a position measuring unit for measuring a position of the moving object using the relative position and a position in a global coordinate system corresponding to the relative position of the detected artificial mark, which is obtained from the map database.

### BRIEF DESCRIPTION OF THE DRAWINGS

The objects and features of the present invention will become apparent from the following description of embodiments given in conjunction with the accompanying drawings, in which:

FIG. 1 is a block diagram illustrating an apparatus of creating a map of artificial marks in accordance with an embodiment of the present invention;

FIG. 2 is a flowchart illustrating a method of creating a map of artificial marks in accordance with an embodiment of the present invention;

FIG. 3 is an exemplary diagram of illustrating the detection of the artificial marks in accordance with an embodiment of the present invention;

FIG. 4 is a view illustrating the calculation of the relative position of the artificial marks in accordance with an embodiment of the present invention;

FIG. 5 is a view illustrating the calculation of a global in a global coordinate system of the artificial mark using the relative position of the artificial mark in accordance with an embodiment of the present invention;

FIG. 6 is a block diagram of an apparatus for measuring a position of a moving object using the map of an artificial marks in accordance with an embodiment of the present invention;

FIG. 7 is a flowchart illustrating a method of measuring a position of a moving object using the map of the artificial marks in accordance with an embodiment of the present invention; and

FIG. 8 is a view illustrating the measurement of a position of a moving object in accordance with an embodiment of the present invention.

### DETAILED DESCRIPTION OF THE EMBODIMENTS

Hereinafter, embodiments of the present invention will be described in detail with reference to the accompanying drawings which form a part hereof.

In the following description of the present invention, if the description of the already known structure and operation may confuse the subject matter of the present invention, the description will be omitted. Accordingly, the meaning of specific terms or words used in the specification and the claims should not be limited to the literal or commonly employed sense, but should be construed in accordance with the scope of the invention.

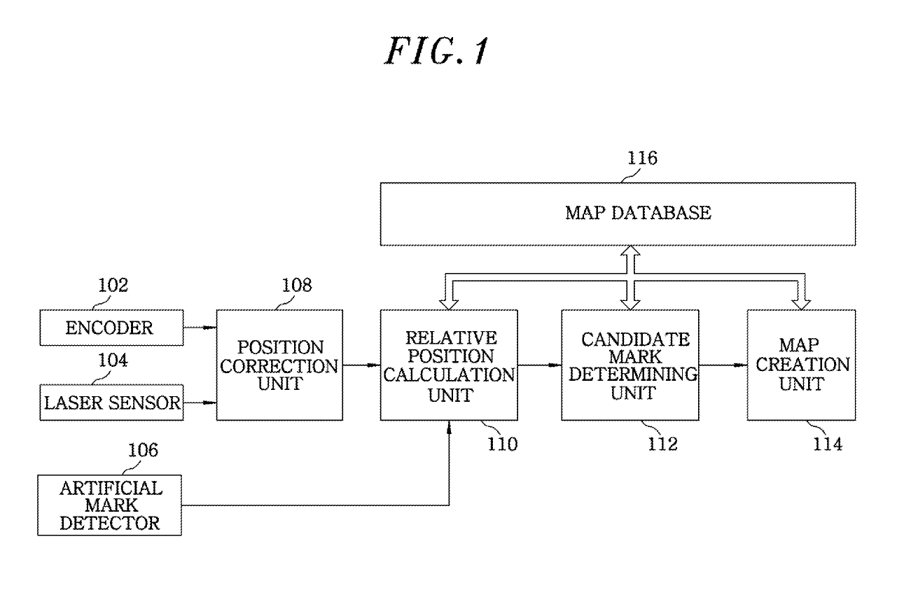

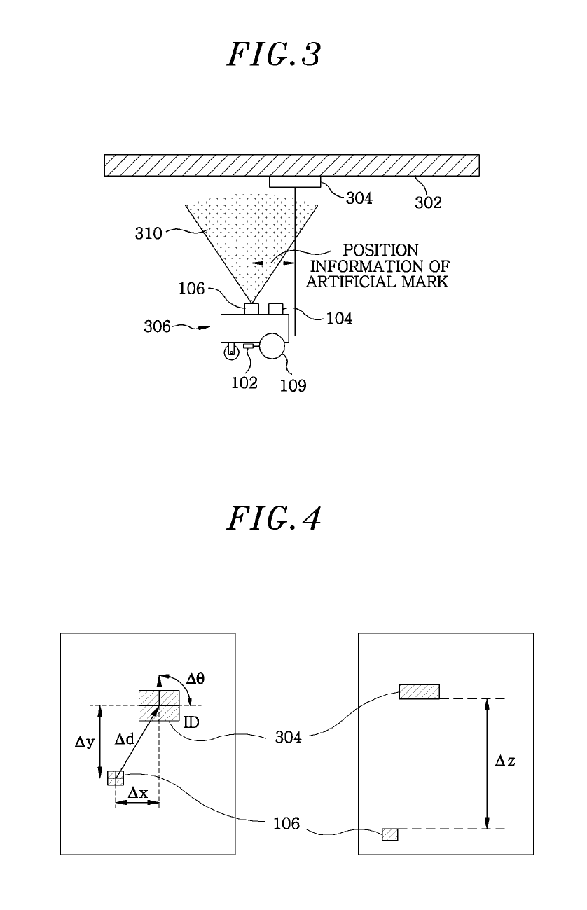

FIG. 1 is a block diagram illustrating an apparatus of creating a map of artificial marks in accordance with an embodiment of the present invention. The apparatus for creating a map of artificial marks includes an encoder 102, a laser sensor 104, an artificial mark detector 106, a position correction unit 108, a relative position calculation unit 110, a candidate mark determining unit 112, a map creation unit 114 and a map database 116. In this embodiment, as illustrated in FIG. 3, the encoder 102, the laser sensor 104, and the artificial mark detector 106 are mounted to a moving object 306.

Remaining components including the position correction unit 108, the relative position calculation unit 110, the candidate mark determining unit 112, the map creation unit 114 and the map database 116 may be carried by the moving object 306 in a form of a circuit board.

The artificial marks 304 are installed on the ceiling 302 in an indoor space and have IDs assigned thereto to distinguish them one another. The moving object 306 is designed to freely travel employing a plurality of wheels 109. The encoder 102 is installed to any one of the wheels 109 and serves to acquire information on a position in which the moving object 306 is moved. The acquired position of the moving object 306 is provided to the position correction unit 108.

The laser sensor 104 measures the position of surrounding objects around the artificial marks 304. The measured position of the surrounding objects is provided to the position correction unit 108.

The artificial mark detector 106 is comprised of, for example, a pointer and a camera. The pointer scans lasers or infrared light within a search range 310 to detect each artificial mark 304 within the search range 310 as shown in FIG. 3. The camera acquires the image of the detected artificial mark 304 within the search range 310. In this embodiment of the present invention, a radio detector such as a receiver may be used instead of the camera. The acquired image of the detected artificial mark 304 is provided to the relative position calculation unit 110.

The position correction unit 108 corrects the position of the moving object 306 using the measured position of the surrounding objects. The corrected position of the moving object 306 is provided to the relative position calculation unit 110. A position correction algorithm such as an extended Kalman filter may be used for the position correction of the moving object 306.

The relative position calculation unit 110 calculates relative position of the detected artificial mark 304 within the search range 310 using the corrected position of the moving object 306 and the image of the detected artificial mark 304. The calculated relative position of the detected artificial mark 302 is stored in the map database 116.

FIG. 4 is a view illustrating the calculation of the relative position of the detected artificial mark 304. The relative position, as illustrated in FIG. 4, is measured in the form of a relative coordinate (ID, Δd, Δθ, Δz) or (ID, Δx, Δy, Δθ, Δz) from an origin that becomes the center of the artificial mark detector 106 or the moving object 306 to a position where the artificial mark 304 is installed. In the relative coordinate, ID refers to an identifier of the artificial mark; Δx refers to X-axis position of the artificial mark with respect to the position of the artificial mark detector 106; Δy refers to Y-axis position of the artificial mark with respect to the artificial mark detector 106; Δz refers to Z-axis position (or height) of the artificial mark with respect to the artificial mark detector 106; Δθ refers to an installation direction of the artificial mark with respect to the artificial mark detector 106; and Δd refers to distance of the artificial mark from the artificial mark detector 106. The relative position calculation unit 110 informs the relative position and the ID of the detected artificial mark of the candidate artificial mark determining unit 112.

The candidate mark determining unit 112 searches the map database 116 to check whether the artificial mark 304 currently detected by the artificial mark detector 106 has been previously detected by comparing the ID of the currently detected artificial mark 304 with the IDs of the previously detected artificial marks. When it is checked that the ID of the currently detected artificial mark is not the IDs of the previously detected artificial marks, the candidate mark determining unit 112 classifies the currently detected artificial mark into a candidate artificial mark to be included in a map of the artificial marks. Information on the classified candidate artificial mark is then provided to the map creation unit 114. However, when it is checked that the ID of the currently detected artificial mark is one of the IDs of the previously detected artificial marks, the candidate mark determining unit 112 compares a distance Δd_{current} from the moving object 306 to the currently detected artificial mark with a distance Δdₚᵣₑᵥᵢₒᵤₛ from the moving object 306 to the previously detected artificial mark. When the distance Δd_{current} is shorter than the distance Δdₚᵣₑᵥᵢₒᵤₛ, the candidate mark determining unit 112 classifies the currently detected artificial mark into a candidate artificial mark to be included in the map. Information on the classified candidate artificial mark is then provided to the map creation unit 114.

The reason to classify the detected artificial mark having a smaller distance as the candidate artificial mark is discussed as follow. The artificial mark detector 106 may precisely measure the position of the artificial marks when the distance from the artificial mark detector 106 to the artificial mark within the searching range is short. Thus, as set forth above, when the artificial mark detected by the artificial mark detector 106 is the same as detected previously, the relatively smaller one of the two distances Δd_{current} and Δdₚᵣₑᵥᵢₒᵤₛ is selected and the artificial mark having the relatively smaller distance is classified into the candidate artificial mark.

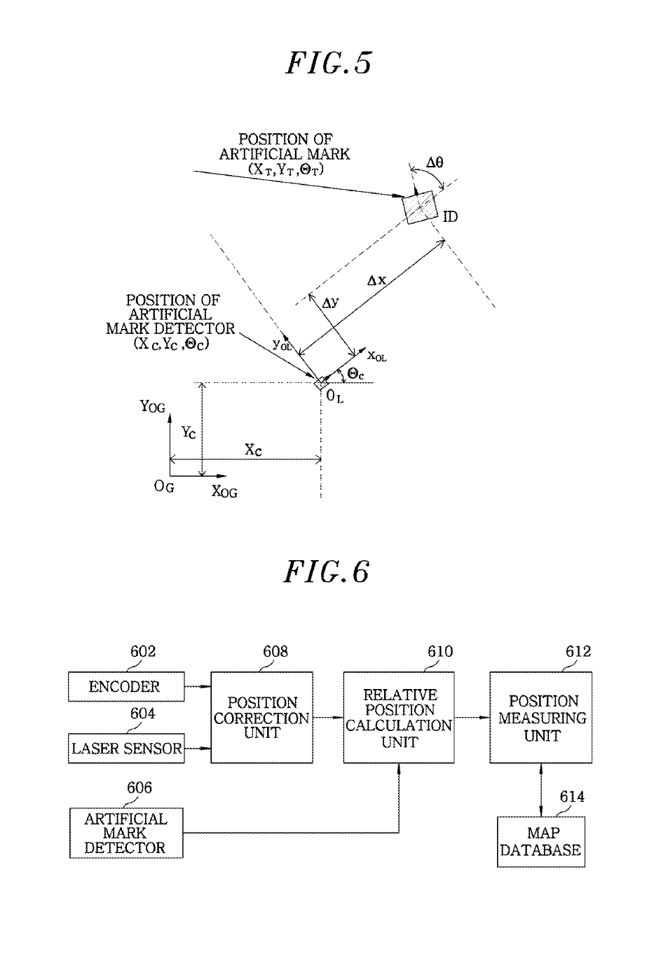

In order to correlate the relative position of the candidate artificial mark with those of the other artificial marks, it is necessary to recognize where the candidate artificial mark is located in an indoor space. To accomplish it, upon receiving the information on the candidate artificial mark from the candidate mark determining unit 112, the map creation unit 114 fetches the relative position of the candidate artificial mark from the map database 116 and transforms the relative position of the candidate artificial mark into a position in a global coordinate system. Such transformation is illustrated in FIG. 5 and is calculated using following Equation 1.

X_{T}=X_{C}+Δx·cos(Θ_{C})−Δy·sin(Θ_{C})

Y_{T}=Y_{C}+Δx·sin(Θ_{C})+Δy·cos(Θ_{C})

Θ_{T}=Θ_{C}+Δθ [Equation 1]

In FIG. 5, O_{G}(X_{OG}^{,} Y_{OG}) is an origin in the global coordinate system; O_{L}(x_{OL}, y_{OL}) is an origin of the artificial mark detector in the local coordinate system; X_{C} and Y_{C} are respectively X-axis and Y-axis positions of the artificial mark detector in the global coordinate system; Θ_{C} is an installation direction of the artificial mark detector in the global coordinate system; X_{T} and Y_{T} respectively denote X-axis and Y-axis positions of the artificial mark in the global coordinate system; and Θ_{T} denotes an installation direction of the artificial mark in the global coordinate system. Further, ID denotes an ID of the artificial mark; Δx and Δy denote relative positions of the artificial mark in the local coordinate system, respectively; and ΔθO denotes an installation direction of the artificial mark in the local coordinate system.

As described above, the map creation unit 114 calculates the global position of the candidate artificial mark using the relative position of the candidate artificial mark and stores the calculated global position and the ID of the candidate artificial mark as map information in the map database 116.

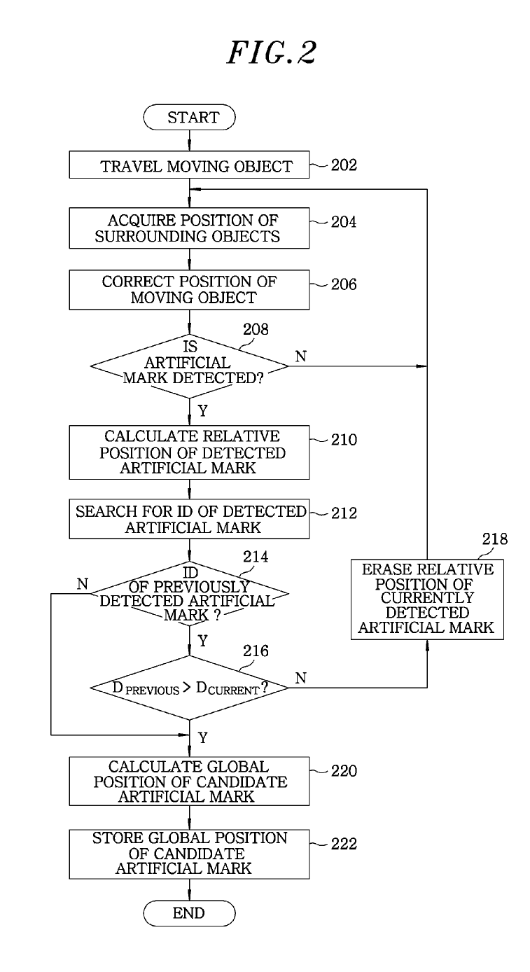

FIG. 2 is a flowchart illustrating a method of creating a map of the artificial marks in accordance with an embodiment of the present invention.

First, in step 202, the moving object 306 travels in the indoor space. In step 204, the encoder 102 measures the position in which the moving object 306 is moved, and the laser sensor 104 measures the position of surrounding objects around the artificial marks. The position of the moving object 306 and the positions of the surrounding objects are provided to the position correction unit 108

In step 206, the position correction unit 108 corrects the position of the moving object 306 using the positions of the surrounding objects, and provides the corrected position of the moving object 306 to the relative position calculation unit 110. The correction of the position of the moving object 306 may be performed using an extended Kalman filter.

Thereafter, in step 208, the artificial mark detector 106 detects an artificial mark 304 within a search range and captures an image of the detected artificial mark 304. The artificial mark detector 106 transmits the captured image of the detected artificial mark 304 to the relative position calculation unit 110.

The relative position calculation unit 110 calculates a relative position of the detected artificial mark 304 using the corrected position of the moving object 306 and the captured image of the detected artificial mark 304. Subsequently, the relative position calculation unit 110 stores the calculated relative position of the detected artificial mark 304 in the map database 116 in step 210. In addition, the relative position calculation unit 110 provides the information about the relative position and the ID of the detected artificial mark 304 to the candidate mark determining unit 112. The information about the relative position and the ID of the detected artificial mark 304 may be represented in the form of relative coordinates such as (ID, Δx, Δy, Δθ, Δz) or (ID, Δd, Δθ, Δz), as illustrated in FIG. 4.

Next, in steps 212 and 214, when receiving the relative position and the ID of the detected artificial mark 304 from the relative position calculation unit 110, the candidate mark determining unit 112 searches for the map database 116 to check whether an ID of the currently detected artificial mark 304 is founded in the map database 116.

As a check result in step 214, when the ID of the currently detected artificial mark is not founded in the map database 116, the candidate mark determining unit 112 classifies the currently detected artificial mark 304 into a candidate artificial mark to be included in a map and provides information of the candidate artificial mark to the map creation unit 114.

However, as the check result of step 214, when the ID of the currently detected artificial mark 304 is founded to be the same as one of the IDs of the previously detected artificial marks, the method goes to step 216 where the candidate mark determining unit 112 compares a distance Δd_{current} from the moving object 306 to the currently detected artificial mark with a distance Δdₚᵣₑᵥᵢₒᵤₛ from the moving object 306 to the previously detected artificial mark in step 216. When the distance Δd_{current} is longer than the distance Δdₚᵣₑᵥᵢₒᵤₛ in step 216, the method returns to the step 204 via step 218.

In step 218, the relative position of the currently detected artificial mark having the distance Δd_{current} longer than the distance Δdₚᵣₑᵥᵢₒᵤₛ may be erased from the map database 116.

Meanwhile, when the distance Δd_{current} is shorter than the distance Δdₚᵣₑᵥᵢₒᵤₛ in step 216, the candidate mark determining unit 112 classifies the currently detected artificial mark into a candidate artificial mark to be included in a map and provides information about the candidate artificial mark to the map creation unit 114.

In response to the information from the candidate mark determining unit 112, the map creation unit 114 fetches the relative position of the candidate artificial mark from the map database 116, calculates the global position of the candidate artificial mark using the fetched relative position in step 220, and stores the calculated global position and the ID of the detected artificial mark as map information in the map database 116 in step 222.

As described above, map information of the artificial marks is created in such a way that the global positions and IDs of all the artificial marks are calculated and stored in the map database by the process automatically performed during the travelling of the moving object.

Next, an apparatus and method of measuring a position of the moving object using an artificial mark map that has been created as explained above will be described.

FIG. 6 is a block diagram of an apparatus for measuring a position of a moving object using the map of the artificial marks in accordance with an embodiment of the present invention. As shown in FIG. 6, the apparatus includes a moving object 306, an encoder 602, a laser sensor 604, an artificial mark detector 606, a position correction unit 608, a relative position calculation unit 610, a position measuring unit 612, and a map database 614.

The moving object 306, the encoder 602, the laser sensor 604, the artificial mark detector 606, the position correction unit 608, and the relative position calculation unit 610 are substantially identical to their respective corresponding components 306, 102, 104, 106, 108, and 110 of FIGS. 1 to 5. Therefore, for the brief illustration without repetition, the details of the identical components will not be further described.

The map database 614 stores global positions of artificial marks that are installed on the ceiling 302 in the indoor space. The global positions of the artificial marks are obtained as described with reference to FIGS. 1 to 5.

When an artificial mark 304 is detected by the artificial mark detector 606, as illustrated in FIG. 3, the relative position calculation unit 610 calculates the relative position of the detected artificial mark 304. The relative position of the detected artificial mark 304 is then provided to the position measuring unit 612 along with an ID of the detected artificial mark 304.

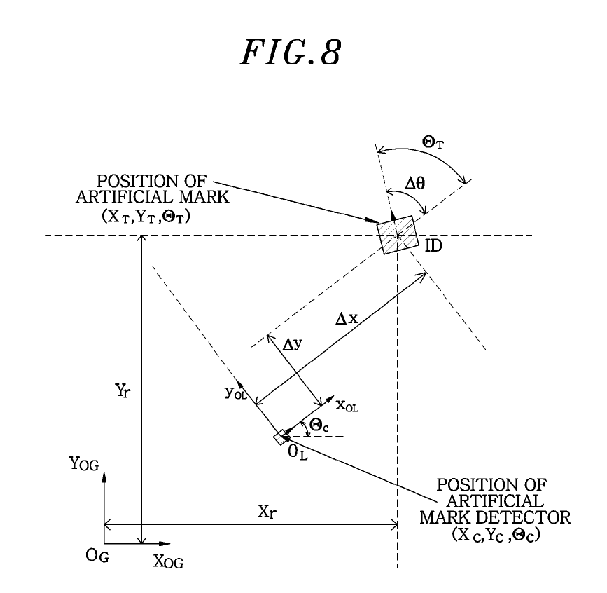

The position measuring unit 612, in response to the information about the relative position and the ID of the detected artificial mark 304 from the relative position calculation unit 610, checks whether the ID of the detected artificial mark 304 exists in the map database 614. When the ID of the detected artificial mark 304 exists in the map database 614, the position measuring unit 612 fetches global position of the detected artificial mark 304 having the ID from the map database 614 and calculates a position of the moving object using the global position and the relative position of the detected artificial mark 304. In more detail, the position measuring unit 612 calculates the position of the moving object using the following Equation 2. FIG. 8 is a view illustrating the measurement of the position of the moving object.

Θ_{C}=Θ_{T}−Δθ

X_{C}=X_{T}−Δx·cos(Θ_{C})+Δy·sin(Θ_{C})

Y_{C}=Y_{T}−Δx·sin(Θ_{C})−Δy·cos(Θ_{C}) [Equation 2]

In FIG. 8, O_{G}(X_{OG}, Y_{OG}) is an origin in the global coordinate system; O_{L}(x_{OL}, y_{OL}) is an origin of the artificial mark detector in the local coordinate system; X_{C}, and Y_{C} are X-axis and Y-axis positions of the artificial mark detector in the global coordinate system, respectively; Θ_{C} is an installation direction of the artificial mark detector in the global coordinate system; X_{T} and Y_{T} are X-axis and Y-axis positions of the artificial mark in the global coordinate system; and Θ_{T} is an installation direction of the artificial mark. Further, ID denotes an ID of the artificial mark; and Δx and Δy denotes relative positions of the artificial mark in the local coordinate system, respectively; and Δθ denotes an installation direction of the artificial mark in the local coordinate system.

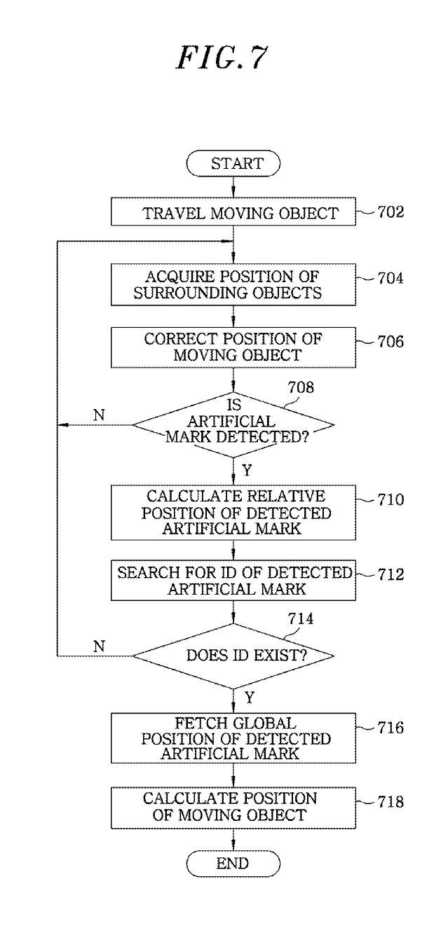

FIG. 7 is a flowchart illustrating a method of measuring a position of the moving object using the artificial mark map in accordance with an embodiment of the present invention.

The process of steps 702 to 710 is substantially identical to those of steps 202 to 210 of FIG. 2. Thus, for the brief illustration without repetition, the detailed description of the same processes will be omitted.

As described above, the relative position calculation unit 610 calculates the relative position of the detected artificial mark 304 and transmits the calculated relative position and the ID of the detected artificial mark 304 to the position measuring unit 612.

Next, the position measuring unit 612 searches for the map database 614 to check whether the ID of the detected artificial mark 304 exists in the map database 614 in steps 712. When the ID of the detected artificial mark does not exist in the map database 614 in decision step 714, the process returns to step 704.

However, when the ID of the detected artificial mark exists in the map database 614 in decision step 714, the position measuring unit 612 fetches the global position of the detected artificial mark 304 from the map database 614 in step 716.

After that, the position measuring unit 612 calculates the position of the moving object 306 using the global coordinate and the relative position of the detected artificial mark 304 in step 718.

As described above, the map may be created by acquiring position of surrounding objects around the artificial marks and an image of the artificial mark to calculate a relative position of the artificial marks and by calculating the global position of the artificial mark using the relative position of the artificial marks. By doing so, time and costs, required to create the map of the artificial marks that are installed in an indoor space where the moving object travels may be remarkably reduced so that artificial mark-based position measuring technology may be realized.

Moreover, the position of the moving object is readily measured rapidly and precisely, using the relative position of the artificial marks and the global coordinate of the artificial mark obtained from the map database.

While the invention has been shown and described with respect to the embodiments, it will be understood by those skilled in the art that various changes and modifications may be made without departing from the scope of the invention as defined in the following claims.

What is claimed is:

1. A method of creating a map of artificial marks installed in an indoor space, the method comprising:
acquiring a position in which a moving object is moved in the indoor space;
detecting each of the artificial marks to obtain an image of the detected artificial mark;
calculating a relative position of the detected artificial mark using the position of the moving object and the image of the detected artificial mark;
calculating a position of the detected artificial mark in a global coordinate system using the calculated relative position; and
storing the calculated position in the global coordinate system and an ID of the detected artificial mark in a map database to create the map of the artificial marks.

2. The method of claim 1, wherein said acquiring a position in which a moving object is moved includes:
measuring the position in which the moving object is moved;
measuring positions of surrounding objects around each of the artificial marks; and
correcting the position of the moving object using the measured position of the moving object and the measured positions of the surrounding objects to produce a corrected position of the moving object,
wherein the corrected position is used to calculate the relative position of the detected artificial mark.

3. The method of claim 2, wherein said correcting the position of the moving object is performed using an extended Kalman filter.

4. The method of claim 1, further comprising:
classfying the detected artificial mark into a candidate artificial mark to be included in the map.

5. The method of claim 4, said classifying the detected artificial mark into the candidate artificial mark comprising:
checking whether the ID of the detected artificial mark is one of IDs of previously detected artificial marks; and
classifying the detected artificial mark into the candidate artificial mark when the ID of the detected artificial mark is not the one of the IDs of the previously detected artificial marks.

6. The method of claim 5, said classifying the detected artificial mark into the candidate artificial mark comprising:
comparing a currently detected distance between the moving object and the detected artificial mark with a previously detected distance between the moving object and the previously detected artificial mark when the ID of the detected artificial mark is one of the IDs of the previously detected artificial marks; and
classifying the detected artificial mark into the candidate artificial mark to be included in the map when the currently detected distance is shorter than the previously detected distance.

7. The method of claim 6, said classifying the detected artificial mark into the candidate artificial mark comprising:
classifying the previously detected artificial mark into the candidate artificial mark to be included in the map, when the currently detected distance is not shorter than the previously detected distance.

8. An apparatus for creating a map of artificial marks installed in an indoor space, the apparatus comprising:
a moving object travelling in the indoor space using a wheel, the moving object including an artificial mark detector mounted to the moving object for detecting each of the artificial marks to obtain an image of the detected artificial mark;
a relative position calculation unit for calculating a relative position of the detected artificial mark using a position in which the moving object is moved and the image of the detected artificial mark; and
a map creation device for calculating a position of the detected artificial mark in a global coordinate system using the calculated relative position; and
a map database storing the calculated position of the detected artificial mark in a global coordinate system.

9. The apparatus of claim 8, further comprising:
an encoder mounted to the wheel of the moving object for measuring the position in which the moving object is moved; and
a laser sensor mounted to the moving object for measuring a position of surrounding objects around each of the detected artificial mark; and a position correction unit for correcting the position of the moving object using the measured position of the surrounding objects,
wherein the corrected position is used to calculate the relative position of the detected artificial mark by the relative position calculation unit.

10. The apparatus of claim 9, wherein the correction of the position in which the moving object is moved is performed by an extended Kalman filter.

11. The apparatus of claim 8, wherein the artificial mark detector comprises:
a pointer for scanning lasers or infrared light within a search range to detect an artificial mark within the search range; and
a camera for acquiring the image of the detected artificial mark within the search range.

12. The apparatus of claim 8, further comprising:
a candidate mark determining unit adapted to classify the detected artificial mark into a candidate artificial mark to be included in the map.

13. The apparatus of claim 12, wherein the candidate mark determining unit is further adapted to check whether the ID of the detected artificial mark is one of IDs of previously detected artificial marks; and
classify the detected artificial mark into the candidate artificial mark when the ID of the detected artificial mark is not the one of the IDs of the previously detected artificial marks.

14. The apparatus of claim 12, wherein the candidate mark determining unit is further adapted to:
compare a currently detected distance between the moving object and the detected artificial mark with a previously detected distance between the moving object and the previously detected artificial mark when the ID of the detected artificial mark is one of the IDs of the previously detected artificial marks; and
classify the detected artificial mark into the candidate artificial mark to be included in the map when the currently detected distance is shorter than the previously detected distance.

15. The apparatus of claims 14, wherein the candidate mark determining unit is further adapted to classify the previously detected artificial mark into the candidate artificial mark to be included in the map when the currently detected distance is not shorter than the previously detected distance.

16. The apparatus of claim 9, wherein the relative position of the artificial mark is calculated into the position in the global coordinate system using the following Equation,
X_{T}=X_{C}+Δx·cos(Θ_{C})−Δy·sin(Θ_{C})
Y_{T}=Y_{C}+Δx·sin(Θ_{C})+Δy·cos(Θ_{C})
Θ_{T}=Θ_{C}+Δθ
where O_{G}(X_{OG}, Y_{OG}) is an origin in the global coordinate system; O_{L}(x_{OL}, y_{OL}) is an origin of the artificial mark detector in the local coordinate system; X_{C} and Y_{C} are X-axis and Y-axis positions of the artificial mark detector in the global coordinate system, respectively; Θ_{C} is an installation direction of the artificial mark detector in the global coordinate system; X_{T} and Y_{T} are X-axis and Y-axis positions of the artificial mark in the global coordinate system, respectively; and Θ_{T} denotes an installation direction of the artificial mark in the global coordinate system.

17. A method of measuring a position of a moving object, the method comprising:
acquiring a position in which the moving object is moved in an indoor space;
detecting each of artificial marks installed in the indoor space to obtain an image of the detected artificial mark;
calculating a relative position of the detected artificial mark using the image of the detected artificial mark and the position of the moving object;
obtaining a position in a global coordinate system corresponding to the relative position of the detected artificial mark; and
measuring a position of the moving object using the relative position and the position in the global coordinate system of the detected artificial mark.

18. The method of claim 17, wherein said acquiring a position in which a moving object is moved in the indoor space includes:
measuring the position in which the moving object is moved;
measuring positions of surrounding objects around each of the artificial marks; and
correcting the position of the moving object using the measured position of the moving object and the measured positions of the surrounding objects to produce a corrected position of the moving object,
wherein the corrected position is used to calculate the relative position of the detected artificial mark.

19. An apparatus for measuring a position of a moving object, the apparatus comprising:
a map database storing positions of the artificial marks in a global coordinate system, wherein each of the artificial marks has an ID assigned thereto to distinguish one another;
an artificial mark detector mounted to the moving object for detecting each of the artificial marks within a search range to acquire an image of the detected artificial mark;
a relative position calculation unit for calculating a relative position of the detected artificial mark by analyzing the acquired image; and
a position measuring unit for measuring a position of the moving object using the relative position and a position in a global coordinate system corresponding to the relative position of the detected artificial mark, which is obtained from the map database.

20. The apparatus of claim 19, wherein the position of the moving object is calculated using the following Equation,
Θ_{C}=Θ_{T}−Δθ
X_{C}=X_{T}−Δx·cos(Θ_{C})+Δy·sin(Θ_{C})
Y_{C}=Y_{T}−Δx·sin(Θ_{C})−Δy·cos(Θ_{C})
wherein O_{G}(X_{OG}^{,} Y_{OG}A is an origin in the global coordinate system; O_{L}(x_{OL}, y_{OL}) is an origin of the artificial mark detector in the local coordinate system; X_{C}, and Y_{C} are X-axis and Y-axis positions of the artificial mark detector in the global coordinate system, respectively; Θ_{C} is an installation direction of the artificial mark detector in the global coordinate system; X_{T} and Y_{T} are X-axis and Y-axis positions of the artificial mark in the global coordinate system, respectively; and Θ_{T} is an installation direction of the artificial mark.
